(19) United States
(12) Patent Application Publication
(10) Pub. No.: US 2014/0105081 A1
(43) Pub. Date: Apr. 17, 2014

(54) COMMUNICATION NETWORK SYSTEM

(71) Applicant: Hirofumi Yamamoto, Obu-city (JP)

(72) Inventor: Hirofumi Yamamoto, Obu-city (JP)

(73) Assignee: DENSO CORPORATION, Kariya-city, Aichi-pref. (JP)

(21) Appl. No.: 14/123,559

(22) PCT Filed: Jul. 18, 2012
(86) PCT No.: PCT/JP2012/004572

§ 371 Date: Dec. 3, 2013

(30) Foreign Application Priority Data
Jul. 19, 2011 (JP) 2011-157894

(51) Int. Cl. H04W 24/02

(52) U.S. Cl. CPC H04W 24/02
USPC 370/310

(57) ABSTRACT

In a communication network system with a plurality of nodes connected to a common transmission line, each master candidate node includes an idle time measurement device for measuring an idle time of the transmission line. Once each master candidate node acquires the master privilege and becomes a master node, the master node retains a master privilege until the idle time of the transmission line exceeds a longest of the privilege acquisition idle time widths of the master candidate nodes, the root node transmits a start frame indicating start of a next communicant cycle and the idle time measurement device is cleared upon receipt of the start frame.

### CROSS REFERENCE TO RELATED APPLICATION

The present application is based on Japanese Patent Applications No. 2011-157894 filed on Jul. 19, 2011, content of which is incorporated herein by reference.

### TECHNICAL FIELD

The present disclosure relates to a communication network system in which multiple nodes connected to a common transmission line communicate with each other.

### BACKGROUND ART

There are arbitration methods for cases where multiple nodes on a common transmission line have a transmission start privilege. One method is a dominant/recessive method adopted in CAN and I2C (registered trademark). Other methods are CSMA/CD and CSMA/CA employed in Ethernet (registered trademark) and wireless LAN. However, because these methods are premised on an event-driven-type communication method, these methods are not applicable to a real-time system that ensures a minimum communication band for each node. As for the real-time system, a time-division method enabling deterministic communications is adopted in FlexRay (registered trademark), TT (time triggered) CAN and the like.

Patent Literature 1 discloses a method of time management synchronized between network nodes. In the method, each node adjusts communication timing thereof in accordance with time information, which is transmitted from a master station at every start of communication cycle.

### PRIOR ART LITERATURE

### Patent Literature

Patent Literature 1 JP2005-159754A

### SUMMARY OF THE INVENTION

The inventor of the present application has considered the following difficulties with respect to a conventional time division method. First, the conventional time division method requires a time management synchronized between network nodes and requires a complicated mechanism such as synchronization adjustment based on a high accuracy clock signal or a synchronization frame. Second, because a communication process for synchronization adjustment is performed at start-up, a start-up time is long. Third, when a node corresponding to an assigned time does not perform transmission, a complicated mechanism is required in order to prevent generation of an empty slot.

The present disclosure is made in view of the foregoing. It is an object of the present disclosure to provide a communication network system that can have a simple configuration to flexibly perform adjustment control for assigning a master privilege.

According to one example of the present disclosure, a communication network system comprising a plurality of nodes connected to a common transmission line is provided. The nodes comprise master candidate nodes each capable of becoming a master node and each including an idle time measurement device for measuring an idle time of the transmission line. The privilege acquisition idle time width is set in each master candidate node and set as a time width of the idle time within which the each master candidate node can acquire a master privilege, which is a privilege of starting communications by itself. The privilege acquisition idle time widths of the master candidate nodes are different in time length from each other. Once a master candidate node acquires the master privilege and becomes the master node, the master node retains the master privilege until the idle time of the transmission line exceeds the privilege acquisition idle time width of the master node. One of the nodes is set as a root node. When the idle time of the transmission line exceeds a longest privilege acquisition idle time width, which is longest among the privilege acquisition idle time widths of the master candidate nodes, the root node transmits a start frame indicating start of a next communicant cycle. Upon receipt of the start frame, the idle time measurement device of each master candidate node is cleared.

According to the above communication network system, it is possible to flexibly perform adjustment control for assigning a master privilege by a simple configuration.

### BRIEF DESCRIPTION OF DRAWINGS

The above and other objects, features and advantages of the present disclosure will become more apparent from the following detailed description made with reference to the accompanying drawings. In the drawings:

FIG. 1 is a time chart illustrating one example communications between nodes via a transmission line according to a first embodiment;

FIG. 2 is a diagram schematically illustrating a configuration of a communication network;

FIG. 3 is a diagram illustrating a configuration of a master privilege acquisition control device;

FIG. 4 is a diagram illustrating a configuration of a master privilege retention time measurement device;

FIG. 5 is a diagram illustrating a bus cycle start control device;

FIG. 6 is a time chart illustrating one example communications between nodes via a transmission line according to a second embodiment;

FIG. 7 is a diagram illustrating a configuration of a master privilege acquisition control device according to the second embodiment;

FIG. 8 is a time chart illustrating one example communications between nodes via a transmission line according to a third embodiment;

FIG. 9 is a flowchart illustrating processes of a master node; and

FIG. 10 is a flowchart illustrating processes of a slave node.

### MODES FOR CARRYING OUT THE INVENTION

### First Embodiment

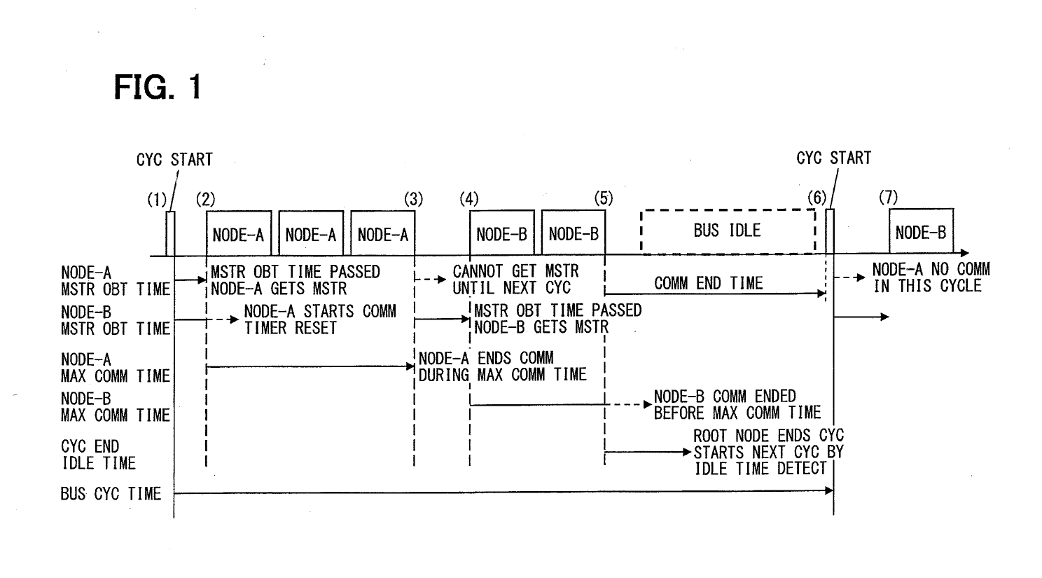

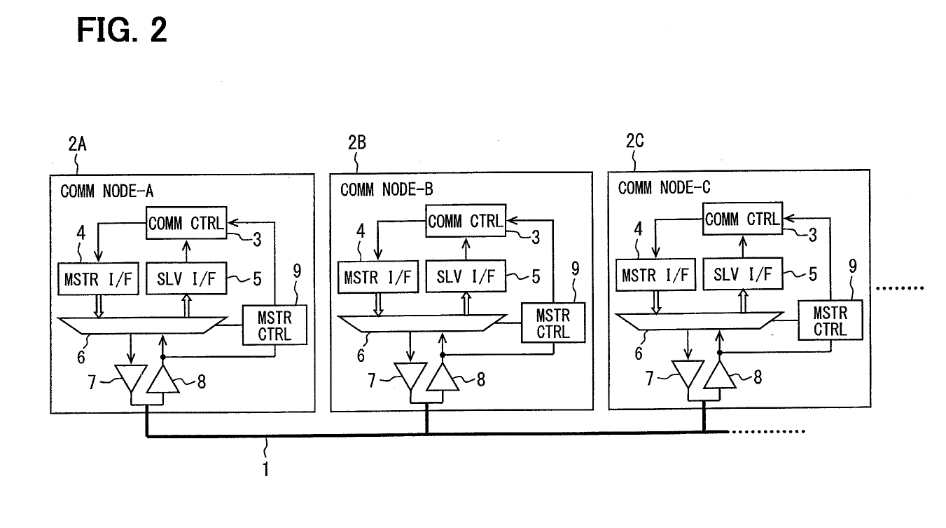

A first embodiment will be described with reference to FIGS. 1 to 5. FIG. 2 is a schematic illustration of a configuration of a communication network system. Multiple communication nodes 2A, 2B, 2C . . . are connected to a transmission line 1 (communication bus). Each communication node 2 includes a communication controller 3, a master interface (I/F) 4, and a slave interface 5. Each communication node 2 uses the master interface (I/F) 4 when this communication node 2 itself functions as a master node. Each communication node 2 uses the slave interface (1/F) 5 when this communication node 2 itself functions as a slave node. In the present embodiment, all of the communication nodes 2 are master candidate nodes.

When the communication node 2 functions as the master, the communication controller 3 performs data encoding or the like via the master interface 4, and then the communication node 2 transmits the data by driving the transmission line 1 via a selector 6 and a transmission buffer 7. When the communication node 2 functions as the slave, the data transmitted to the transmission line 1 is received via a reception buffer 8, the slave interface 5 performs the decoding or the like via the selector 6, and the received data is inputted to the communication controller 3.

The master privilege controller 9 (corresponding to a master privilege control device) performs a switching control of the selector 6. By monitoring a state of the transmission line 1 via the reception buffer 8, the master privilege controller 9 determines whether or not the node 2, to which the master privilege controller 9 itself belongs, has acquired a master privilege. When the master privilege is acquired, the master privilege controller 9 outputs the data, which is outputted via the slave interface 5, to the transmission buffer 7 via the selector 6. In other cases, the node basically functions as a salve. Thus, the data received via the reception buffer 8 is inputted to the salve interface 5 via the selector 6. Incidentally, various signals outputted from the master privilege controller 9 are inputted to the communication controller 3.

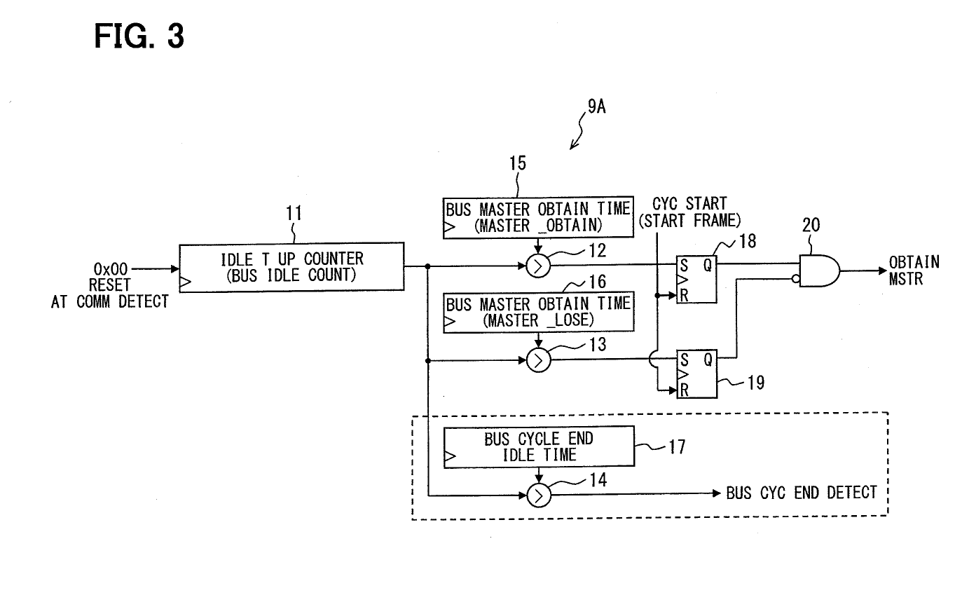

FIGS. 3 to 5 illustrate respective functional portions of the master privilege controller 9. FIG. 3 illustrates a master privilege acquisition control device 9A. An idle time up counter 11 (referred to hereinafter as a counter 11, corresponding to an idle time measurement means or an idle time measurement device) is a counter that is reset each time any master transmits a data to the transmission line 1. Its counter value is inputted to three data comparators 12, 13, 14. These data comparators 12, 13, 14 compare the counter value with register values of registers 15, 16, 17, respectively.

It is noted that a clock signal line is omitted from the drawings. Herein, an idle refers to a state where the data or the like is not outputted to the transmission line 1 and the communication is not performed. Therefore, the counter 11 measures a duration of the idle of the transmission line 1.

A privilege acquisition idle time (Bus Master Obtain Time) is set in the register 15, wherein the privilege acquisition idle time is a time for the communication node 2, to which the register 15 itself belongs, to acquire the master privilege. When the counter value exceeds the register value, the data comparator 12 outputs a high active signal to a set terminal S of a RS flip-flop 18. A privilege lose time (Bus Master Loose Time) is set in the register 16, wherein the privilege lose time is a time of losing the acquired master privilege of the communication node 2. When the counter value exceeds the register value, the data comparator 13 outputs a high active signal to a set terminal S of a RS flip-flop 19.

Therefore, each node 2 can acquire the master privilege within a time width (privilege acquisition idle time width), which is a time width from when the idle time exceeds the privilege acquisition idle time to when the idle time exceeds the privilege lose time. In each node 2, the privilege, acquisition idle time and the privilege lose time are different from each other.

A communication end time (Bus Cycle End Idle Time) indicating the end of the communication cycle is set in the register 17. When the counter value exceeds the register value, the data comparator 14 outputs a high-active bus cycle end detection signal. It is noted that the data comparator 14 and the register 17 are equipped in only the communication node 2 that has a function of a root node. The communication end time is set longer than a longest privilege acquisition idle time, which is longest among the privilege acquisition idle times of respective communication nodes 2.

A cycle start signal (start frame), which is outputted from the root node to the transmission line 1, is provided to reset terminals R of the RS flip-flops 18, 19. Output terminals Q of the RS flip-flops 18, 19 are connected to the input terminals of the AND gate 20, respectively. It is noted that the input terminal of the RS flip-flop 19 has a negative logic. The AND gate 20 outputs a master privilege acquisition signal (high active). The master privilege acquisition signal is inputted to the communication controller 3 and the below-described master privilege retention time measurement device 9B.

Therefore, upon the output of the cycle start signal to the transmission line 1, the RS flip-flops 18, 19 are reset. When the counter value of the counter 11 exceeds the register value of the register 15, which is the privilege acquisition idle time width, the RS flip-flop 18 is set and the AND gate 20 makes a master privilege acquisition signal active. Thereafter, when the counter value of the counter 11 exceeds the register value of the register 16, which is the privilege lost time, the RS flip-flop 19 is set and the AND gate 20 makes the master privilege acquisition signal inactive.

It is noted that because the cycle start signal is more or less transmission of a specific data to the transmission line 1, the counter 11 is reset upon the transmission of the cycle start signal.

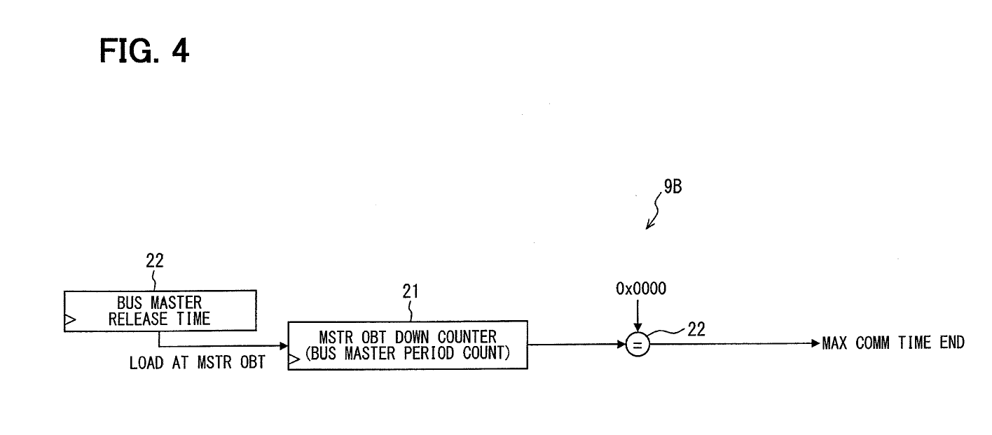

FIG. 4 illustrates a configuration of a master privilege retention time measurement device 9B (corresponding to a master privilege release means or a master privilege release device). A register value corresponding to a master privilege release time (Bus Master Release Time), which is set in the register 22, is loaded to a master acquisition down counter (Bus Master Period Count) 21 at a time when the master acquisition signal becomes active. The master acquisition down counter 21 performs a down count operation based on a clock signal, which is a common clock signal supplied to the counter 11. A counter value of the master acquisition down counter 21 is inputted to the comparator 22. When the counter value becomes zero, the comparator 22 outputs a signal indicating a maximum communication time end. This signal is inputted to the communication controller 3. It is noted that the below-illustrated operations of respective counters are premised on a common clock signal for their operations.

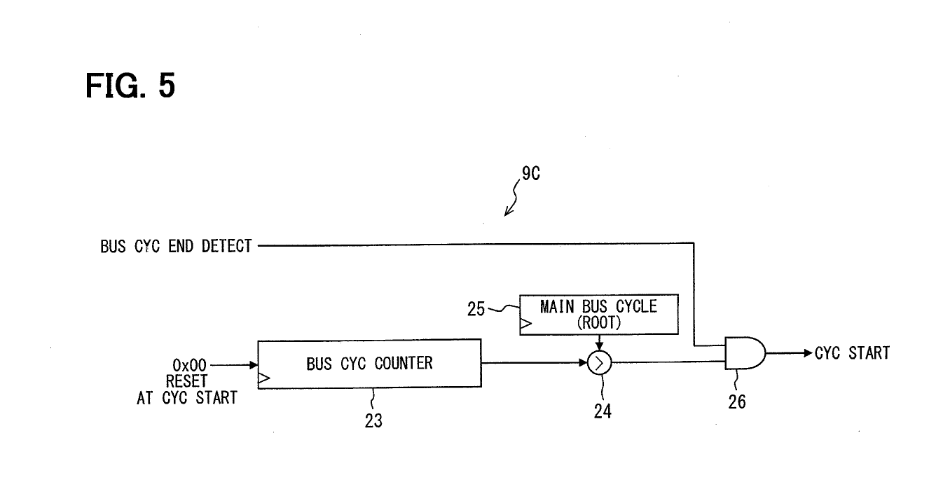

FIG. 5 illustrates a configuration of a bus cycle start control device 9C. It is noted that he bus cycle start control device 9C is equipped in only the communication node 2 that has the function of the root node. A bus cycle counter 23 (corresponding to a communication cycle time measurement means or a communication cycle time measurement device) is reset and started at a time when it outputs the cycle start signal. A counter value of the bus cycle counter 23 is inputted to the data comparator 24.

The data comparator 24 compares the above counter value with the register value of the register 25. A communication bus cycle time (Main Bus Cycle (root)) is set in the register 25. When the counter value exceeds the register value, the data comparator 24 inputs a high active signal to one of the input terminals of the AND gate 26. The other of the input terminal of the AND gate 26 is provided with a bus cycle end detection signal from the master privilege acquisition control device 9A. Then the AND gate 26 outputs the cycle start signal. In the above, the communication bus cycle time, which is set in the register 25, specifies a minimum time of communication cycle.

Operations of the present embodiment will be illustrated with reference to FIG. 1. FIG. 1 is a time chart showing one example when the communication nodes 2 communicate via the transmission line 1. At (1), when the root node outputs the cycle start signal, the counter 11 of the master privilege acquisition control device 9A is reset and started. The communication node having the smallest privilege acquisition idle time width in the register 15 first acquires the master privilege. For example, the communication node 2A (node A) first acquires the master privilege. At (2), the communication node having the smallest privilege acquisition idle time width starts communications. Accordingly, the counter 11 is reset. When the communication node 2A starts communications, its master privilege is retained until the time measured by the master privilege retention time measurement device 9B exceeds the master privilege release time, that is, until the maximum communication time end signal is outputted.

At (3), when the communication node 2A ends communications, the counter 11 measures the idle time from a time when the communication node 2A ends communications. Then, when the idle time exceeds the privilege lose time, the RS flip-flop 19 is set and the master privilege acquisition of the communication node 2A becomes inactive and the communication node 2A loses the master privilege. Therefore, until the idle time exceeds the privilege lose time, the communication node 2A can again start communications.

When the communication node 2A loses the master privilege and thereafter a longer idle time is measured, the communication node 2B (node B) having the longest privilege acquisition idle time width next to the communication node 2A acquires the master privilege. At (4), the communication node 2B starts communications. At (5), when the communication node 2B ends communications, the counter 11 measures the idle time from a time when the communication node 2A ends communications. Thereafter, when another communication node 2 does not start communications, the measured idle time becomes longer. When the measured idle time exceeds the communication end time, the master privilege acquisition control device 9A outputs the bus cycle end detection signal.

In the root node, the bus cycle start control device 9C measures the bus cycle time from a time when the bus cycle counter 23 outputs the cycle start signal. Then, when this measured time exceeds the communication bus cycle time and the cycle start signal is outputted, the bus cycle start control device 9C outputs the cycle start signal for starting a next communication cycle at (6). In the next communication cycle, because the communication node 2A did not start communications within the first idle time span, the communication node 2B has acquired the master privilege and started communications at (7).

For example, at (2), if the duration of the continuous communication by the communication node 2A exceeds the master privilege release time, the master privilege retention time measurement device 9B outputs the maximum communication time end signal. In this case, the communication controller 3 ends communications at a time of completion of the presently-executed communication (one frame).

As described above, according to the present embodiment, each communication node 2 includes the counter 11 for measuring the idle time of the transmission line 1. The privilege acquisition idle time width, which is a time width of the idle time of the transmission line 1 within which the communication node 2 can acquire the master privilege as a privilege to start communications, is different in time length from one communication node 2 to another communication node 2. Once the communication node 2 acquires the master privilege and becomes the master node, the communication node 2 retains the master privilege until the idle time of the transmission line 1 exceeds the privilege acquisition idle time width of the communication node 2 being the master node. One of the multiple communication nodes 2 is set as the root node. When the idle time of the transmission line 1 exceeds the longest privilege acquisition idle time width among those assigned to respective communication nodes 2, the root node transmits the cycle start signal indicating the start of a next communication cycle, so that the counters 11 of respective communication nodes 2 are reset upon the receipt of the cycle start signal.

That is, the privilege acquisition time widths of the communication nodes 2 are different from each other. Thus, within one communication cycle, it is ensured that no collision occurs and each communication node 2 has a privilege to surely become the master node at least one time. The master privilege once acquired by the communication node 2 is retained until the idle time exceeds the privilege acquisition idle time width of the communication node 2 that has acquired the master privilege. Thus, under this limit, the communication node 2 can flexibly perform the communications. Therefore, while surely having a privilege to become the master node at least one time within one communication cycle, each communication node 2 can communicate in a flexible manner. Communication efficiency improves.

When the time of retention of the master privilege exceeds the maximum retention time, the communication node 2 releases the master privilege by outputting the maximum communication time end signal from the master privilege retention time measurement device 9B. Therefore, it is possible to flexibly perform communications, and it is possible to present a situation in which one master communication node 2 exclusively occupies the transmission line 1 for an inappropriate long time. An opportunity for other communication nodes 2 to perform communications can be reliably ensured.

Moreover, the root node transmits the cycle start signal if: the duration time of the communication cycle exceeds the preset communication bus cycle time; and the idle time exceeds the longest the privilege acquisition idle time width. It is conceivable that the number of communication nodes 2 connected to the transmission line 1 is small in the following situation: the idle time exceeds the longest privilege acquisition idle time width even though a small amount of time has elapsed since the last cycle start signal was transmitted and the communication cycle was newly started. Therefore, when the start frame is transmitted on the condition that the minimum time of the communication cycle has elapsed, the number of transmission of the start frame and the number of execution of communication cycle can be reduced and unneeded power consumption can be reduced in cases where a communication traffic volume of the transmission line 1 is small. Additionally, even when the number of communication nodes 2 connected to the transmission line 1 is increased or decreased, an associated change in system setting can be easily made.

### Second Embodiment

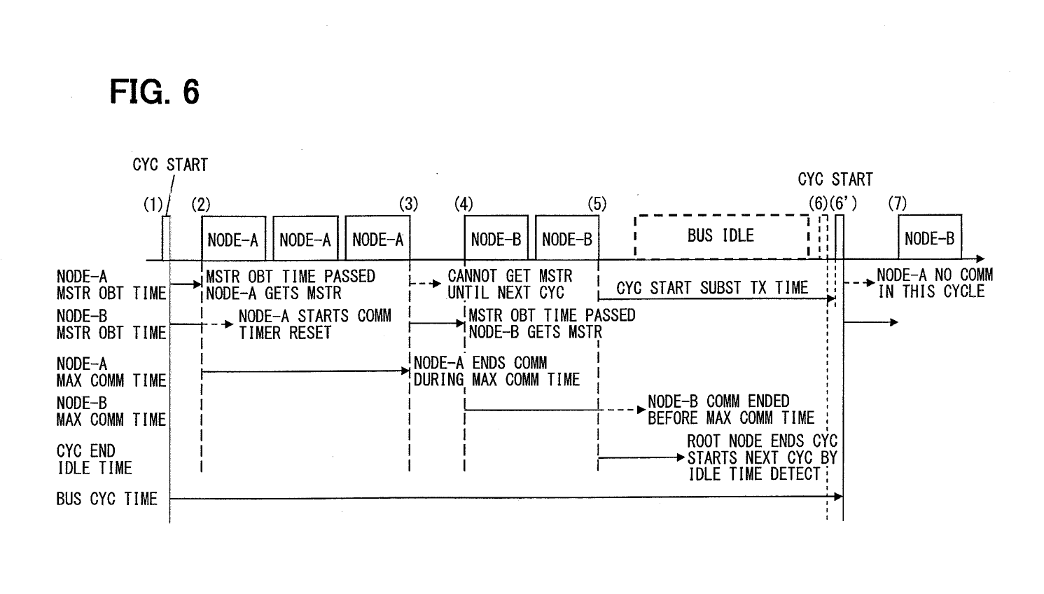

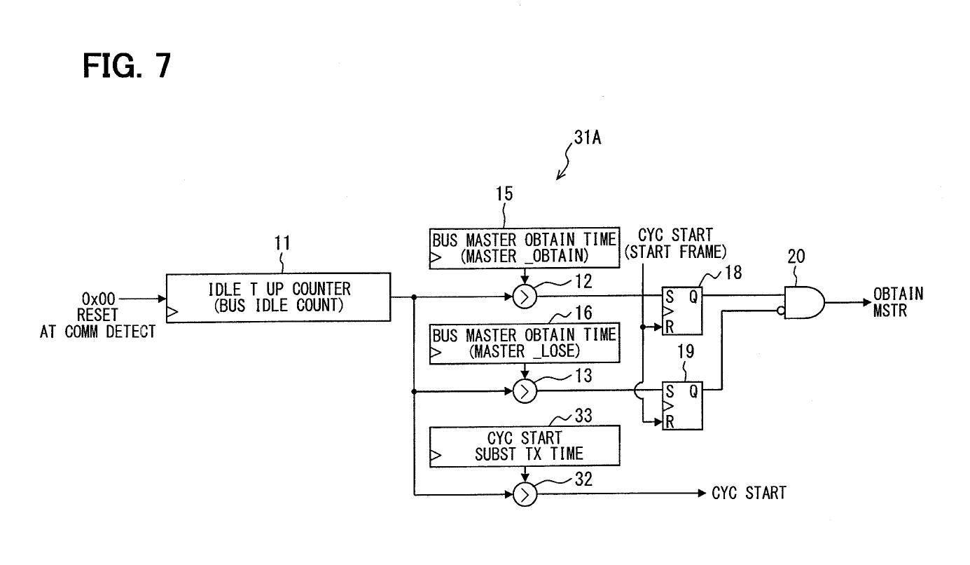

FIGS. 6 and 7 illustrate the second embodiment. In the first and second embodiments, like parts are referred to by like references. Explanation on like parts may be omitted and explanation on different parts may be given. FIG. 7 is a diagram corresponding to FIG. 3 and illustrates a configuration of a master privilege control device 31A. The master privilege control device 31A of the second embodiment includes a data comparator 32 and a register 33 (corresponding to a start frame substitution transmission means or a start frame substitution transmission device). The data comparator 32 and the register 33 correspond to the data register 14 and the register 17, which are provided in only the communication node 2 assigned the function of the root node in the first embodiment. A cycle start substitution transmission time is set in the register 17. The cycle start substitution transmission time is longer than the communication end time, which is set in the register 17 of the communication node 2 having the function of the root node.

Operations of the second embodiment will be illustrated with reference to FIG. 6. When the root node normally functions, the cycle start signal is transmitted in the timing (6) as described in the first embodiment. However, for example, when the root node has a failure and the cycle start signal is not transmitted in the timing (6), the measured time of the counter 11 of another communication node 2 including the master privilege control device 31A exceeds the cycle start substitution transmission time. In this case, in the timing (6)′, the another communication node 2 transmits the cycle start signal. That is, the another communication node 2 substitutes the function of the root node.

There may be multiple communication nodes 2 each including the master privilege control device 31A. In this case, the cycle start substitution transmission time, which is set in the register 33, may differ from one communication node 2 to another communication node 2 (may be set longer in turn), so that the multiple communication nodes 2 substitute the function of the root node in turn. Furthermore, like the root node, the master privilege control device 31A may include the configuration illustrated in FIG. 5, so that the cycle start signal is transmitted on the condition that the minimum time of the communication cycle has elapsed.

As described above, in the second embodiment, the communication node 2 other than the initial root node measures the idle time (cycle start substitute transmission time) longer than the longest privilege acquisition idle time measured by the root node. When the cycle start signal is not transmitted and the idle time measured by the communication node 2 other than the initial root node exceeds the cycle start substitute transmission time, the communication node 2 other than the initial root node transmits the cycle start signal by substituting the initial root node. Therefore, even when the initial root node has a failure, the communication node can start a next communication cycle by substituting the function of the initial root node and transmitting the cycle start signal.

Furthermore, multiple communication nodes 2 for substituting the function of the root node are previously set. The multiple communication nodes 2, respectively, measure the cycle start substitute transmission times, which are longer than the longest privilege acquisition idle time width measured by the root node and which are different in time length from each other. In this configuration, even if some of the multiple communication nodes 2 has a failure, the others of the multiple communication nodes 2 can substitute the function in turn.

### Third Embodiment

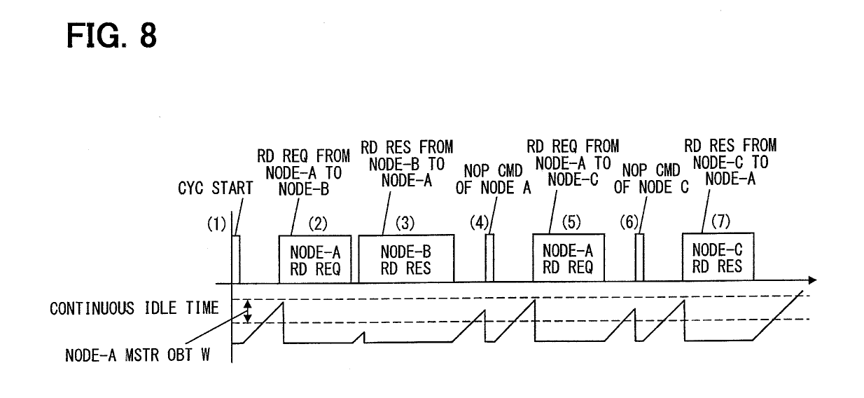

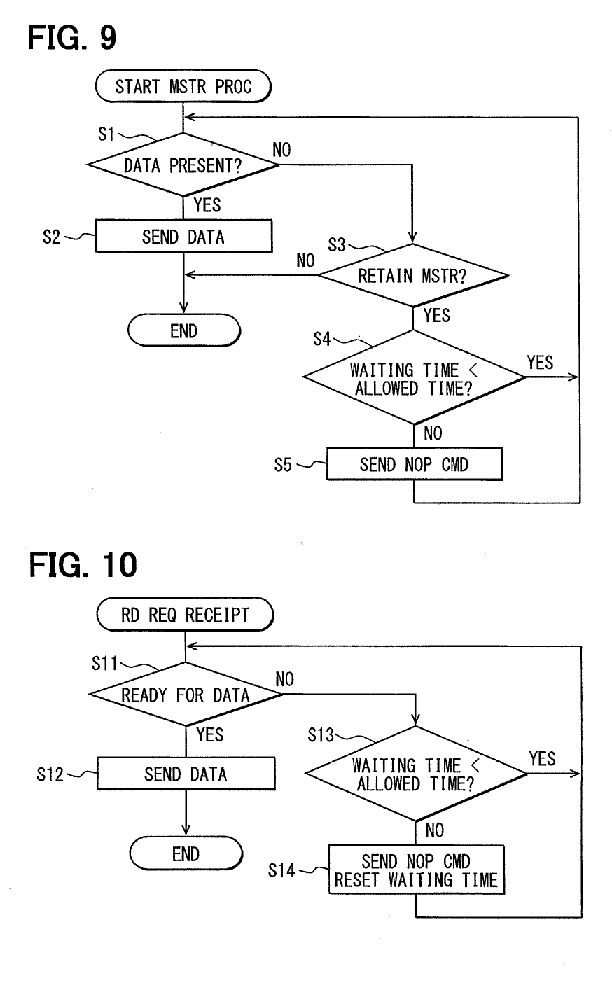

FIGS. 8 to 10 illustrate the third embodiment. FIG. 8 illustrates a situation where the communication node 2A acquires the master privilege, and the communication nodes 2B and 2C perform communications as the slaves. This drawing illustrates a change in the idle time measured by the counter 11 and the privilege acquisition idle time width (master privilege acquisition window) of the communication node 2A. FIG. 9 is a flowchart illustrating processing of the communication node 2A serving as the master. FIG. 10 is a flowchart illustrating processing of each communication node 2B, 2C serving as the slave. These drawings illustrate only main portions associated with the third embodiment.

At (1), the communication cycle is started in response to the cycle start signal and the communication node 2A acquires the master privilege. In this case, as shown in FIG. 9, when the communication node 2A determines that there is a data to be transmitted (YES at S1), the communication node 2A transmits the data to the transmission line 1. As shown in FIG. 8, at (2), the communication node 2A transmits a read request to the communication node 2B. At (3), upon receipt of the read request, the communication node 2B transmits a data to the communication node 2A (read response; RD res). Next, it is assumed that the communication node 2A does not have a data to be transmitted (NO at S1) but the communication node 2A has a request to acquire the master privilege (YES at S3). That is, the communication node 2A is almost ready to prepare the data to be transmitted.

At this time, the communication node 2A waits to transmit the data thereof and measures this waiting time. When the waiting time is smaller than an allowed time (YES at S4), the process returns to S1. In the above, the allowed time refers to a time within which the communication node 2A can retain the master privilege without performing data transmission. The allowed time is set smaller than the privilege lose time. At S4, when the waiting time becomes greater than or equal to the allowed time (YES), the communication node 2A transmits a NOP (no operation) command to the transmission line 1 and resets the counter counting the waiting time (S5), and the process proceeds to S1.

Herein, the NOP command is the same as a NOP command specified as a kind of command of the CPU and ignored by its receiver without processing. At (4) of FIG. 8, the communication node 2A transmits the NOP command and the counter 11 is reset by this transmission. Accordingly, the communication node 2A avoids losing the master privilege and can continue the communications.

Subsequently, at a time (5) when the data to be transmitted is present at S1, the communication node 2A transmits a read request (RD req) to the communication node 2C. In FIG. 10, when the communication node 2C is ready for the data to be transmitted (YES), the communication node 2C transmits the data (S12). When the communication node 2C is not ready for the data to be transmitted (NO), the communication node 2C waits to transmit the data and measure the waiting time in a manner similar to S5 in a manner similar to S4 and S5 of FIG. 9. When the waiting time is smaller than an allowed time (YES at S13), the process returns to S11. The allowed time in the above is set based on the same idea as that in S4.

When the waiting time becomes greater than or equal to the allowed time at S13 (YES), the communication node transmits the NOP command to the transmission line 1 and resets the counter (S14), and the process returns to S11. At (6) of FIG. 8, the NOP command is transmitted by the communication node 2C and the counter 11 is reset because of this transmission. Accordingly, the communication node 2A avoids losing the master privilege and can continue the communications. Thereafter, at a time (7) when the communication node 2C is ready for the data to be transmitted at S11, the communication node 2C transmits the data (RD res) to the communication node 2A.

As described above, according to the third embodiment, when the communication node 2A determines that during the retention of the master privilege by the communication node 2A, the communication node 2A cannot transmit the data, the communication node 2A transmits the NOP data, which is not processed by its receiver. Additionally, in a similar way, the slave node transmits the NOP command if: the salve node such as the communication node 2C is requested to transmit a data by the communication node 2A; and the requested salve node determine that during the retention of the master privilege by the communication node 2A, the requested salve node cannot respond. Therefore, during the communication node 2A's retention of the master privilege, the time for transmitting the data can be ensured.

The embodiments described above and illustrated in the drawings do no limit the present disclosure but can be modified or extended in, for example, the following ways.

The functions of the root node may be previously provided to all communication nodes, so that at initial setting, one of the communication nodes may be designated the root node.

The master candidate nodes may not be all of the nodes. There may be a node that has only the function of the slave.

The setting of the elapse of the communication cycle time as a condition for transmitting the cycle start signal may be provided on an as-needed basis.

When it is certain from communication specifications that the communication time of each node finishes within a predetermined time period, it may be unnecessary to provide the master privilege release means (master privilege release device).

### Aspects

According to the present disclosure, a communication network system can be provided in various forms.

According to one form, a communication network system comprising a plurality of nodes connected to a common transmission line is configured as follows. The nodes comprise master candidate nodes each capable of becoming a master node and each including an idle time measurement device for measuring an idle time of the transmission line. The privilege acquisition idle time width is set in each master candidate node and set as a time width of the idle time within which the each master candidate node can acquire a master privilege, which is a privilege of starting communications by itself. The privilege acquisition idle time widths of the master candidate nodes are different in time length from each other. Once a master candidate node acquires the master privilege and becomes the master node, the master node retains the master privilege until the idle time of the transmission line exceeds the privilege acquisition idle time width of the master node. One of the nodes is set as a root node. When the idle time of the transmission line exceeds a longest privilege acquisition idle time width, which is longest among the privilege acquisition idle time widths of the master candidate nodes, the root node transmits a start frame indicating start of a next communicant cycle. Upon receipt of the start frame, the idle time measurement device of each master candidate node is cleared.

In the below illustration, the master nodes may refer to a first node, a second . . . , and a n-th node in ascending order of the privilege acquisition idle time width. When the communication cycle is started in response to the transmission of the start frame by the root node, the first node assigned a shortest privilege acquisition idle time width first acquires the master privilege and starts communications. When the first node ends communications, the first master no longer again acquires the master privilege in this communication cycle. Thereafter, when the idle time of the transmission line reaches the privilege acquisition idle time width of the second node, the second node acquires the master privilege and starts communications.

Thereafter, the master candidate nodes sequentially acquire the master node and perform communications. When the n-th node having the longest privilege acquisition idle time width finishes communications, the subsequent idle time of the transmission line continues for more than the longest privilege acquisition idle time width assigned to the n-th node. Then the root node detects this state and transmits the start frame indicating a next communication cycle. Therefore, because the privilege acquisition idle time widths of the master candidate nodes are different from each other, it is ensured that within one communication cycle, the collision does not occur and every master candidate node is provided with one opportunity to become the master node.

Furthermore, as to each master candidate node, because the master right once acquired by the master candidate node is retained as long as the idle time does not exceed the privilege acquisition idle time width of the master candidate node, the master candidate node can flexibly perform communications under this limit.

For example, when communication ends though a length of this communications is still for the x-th node to be the master node, the x+1-th node starts communications at a time when the idle time reaches the next privilege acquisition idle time width. Therefore, because it is ensured that within one communication cycle, the collision does not occur and every master candidate node is provided with one opportunity to become the master node, it is possible to improve communications efficiency. Additionally, even when the number of nodes connected to the communication network is increased or decreased, it is possible to easily make an associated change in system setting.

The above communication network system may be configured as follows. The master node may include a master privilege release device for releasing the master privilege when a time period of retention of the master privilege by the master node exceeds a maximum retention time. According to this, while flexible communication manners are possible, it is possible to avoid a situation where one master candidate node becomes the master and occupies the transmission line for an inappropriate long time, and it is possible to reliably ensure opportunities for other master candidate nodes to perform communications.

The above communication network system may be configured as follows. The root node may include a communication cycle time measurement device for measuring a duration of a communication cycle, wherein a starting point of the communication cycle is the transmission of the start frame. The root node may transmit the start frame if the duration of the communication cycle exceeds a predetermined minimum time and the idle time of the transmission line exceeds the longest privilege acquisition idle time width. According to this, by transmitting the start frame subject to the elapse of the minimum time of the communication cycle, it is possible to reduce the number of transmission of the start frame in cases of a small communication traffic amount and it is possible to reduce the number of execution of communication cycle and unneeded power consumption.

The above communication network system may be configured as follows. The nodes other than the root node may include a node for substituting the root node. The node for substituting the root node may transmit the start frame to substitute the root node when: there is no transmission of the start frame; and the idle time measured by the node substituting the root node exceeds a certain idle time that is longer than the longest privilege acquisition idle time width measured by the root node. According to this, even if a node assigned to the function of the root node has a failure and one of the other nodes detects no transmission of the start frame in a situation where the root node should have transmitted the start frame, the one of the other nodes can substitute the function of the root node and transmit the start frame, thereby starting a next communication cycle.

The above communication network system may be configured as follows. The nodes include a plurality of the nodes for substituting the root node. The plurality of the nodes for substituting the root node measures the certain idle times that are different in time length from each other and that are longer than the longest privilege acquisition idle time width measured by the root node. According to this, the plurality of the nodes for substituting the function of the root node can be previously set and the certain idle times different in time length from each other and longer than the longest privilege acquisition idle time width measured by the root node can be set different from each other. Therefore, even if some of the plurality of the nodes has a failure, the plurality of the nodes can subsequently substitute the function.

The above communication network system may be configured as follows. When the requested node, which is the node requested by the master node to transmit a data, determines that the requested node cannot respond during the retention of the master privilege by the master node, the requested node transmits a data that is not processed by a receiver. According to this, when the node (slave node) requested by the master node to transmit a data determines that the requested node cannot respond during the retention of the master privilege by the master node, the requested node transmits a data that is not processed by a receiver. Therefore, while the master privilege is being retained by the master node, the salve node can ensure a time for the salve node to transmit the requested data.

The above communication network system may be configured as follows. When the master node determines that the master node cannot transmits a data during the retention of the master privilege by the master node, the master node transmits a data that is not processed by a receiver. According to this, while retaining the master privilege, the master node can ensure a time for the master node to transmit the data.

According to another form, a master privilege controller is provided. The master privilege controller is provided in each master candidate node, which is included in a plurality of nodes connected to a common transmission line in a communication network and which is capable of becoming a master node. The master privilege controller comprises the above-described idle time measurement device. This can also provide the above-described advantages.

The master privilege controller may further comprise a master privilege release device. A privilege acquisition idle time width may be set in each master candidate node and set as a time width of the idle time within which the each master candidate node can acquire a master privilege, which is a privilege of starting communications by itself. The privilege acquisition idle time widths of the master candidate nodes may be different in time length from each other. Once a master candidate node acquires the master privilege and becomes the master node, the master node may retain the master privilege until the idle time of the transmission line exceeds the privilege acquisition idle time width of the master node. One of the nodes may be set as a root node. When the idle time of the transmission line exceeds a longest privilege acquisition idle time width, which is longest among the privilege acquisition idle time widths of the master candidate nodes, the root node may transmit a start frame indicating start of a next communicant cycle. The master privilege release device may release the master privilege when a time period of retention of the master privilege by the master node exceeds a maximum retention time.

The master privilege controller may further comprise a communication cycle time measurement device for measuring a duration of a communication cycle, wherein a starting point of the communication cycle is the transmission of the start frame. When the master candidate node including the master privilege controller is the root node, the root node may transmit the start frame if the duration of the communication cycle exceeds a predetermined minimum time and the idle time of the transmission line exceeds the longest privilege acquisition idle time width.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

1. A communication network system comprising
a plurality of nodes connected to a common transmission line, wherein:
the nodes comprise master candidate nodes each capable of becoming a master node and each including an idle time measurement device for measuring an idle time of the transmission line;
a privilege acquisition idle time width is set in each master candidate node and set as a time width of the idle time within which the each master candidate node can acquire a master privilege, which is a privilege of starting communications by itself;
the privilege acquisition idle time widths of the master candidate nodes are different in time length from each other;
once a master candidate node acquires the master privilege and becomes the master node, the master node retains the master privilege until the idle time of the transmission line exceeds the privilege acquisition idle time width of the master node;
one of the nodes is set as a root node;
when the idle time of the transmission line exceeds a longest privilege acquisition idle time width, which is longest among the privilege acquisition idle time widths of the master candidate nodes, the root node transmits a start frame indicating start of a next communicant cycle; and
upon receipt of the start frame, the idle time measurement device of each master candidate node is cleared.

2. The communication network system according to claim 1, wherein
the master node includes a master privilege release device for releasing the master privilege when a time period of retention of the master privilege by the master node exceeds a maximum retention time.

3. The communication network system according to claim 1, wherein:
the root node includes a communication cycle time measurement device for measuring a duration of a communication cycle, wherein a starting point of the communication cycle is the transmission of the start frame; and
the root node transmits the start frame if the duration of the communication cycle exceeds a predetermined minimum time and the idle time of the transmission line exceeds the longest privilege acquisition idle time width.

4. The communication network system according to claim 1, wherein:
the nodes other than the root node includes a node for substituting the root node; and
the node substituting the root node transmits the start frame to substitute the root node when: there is no transmission of the start frame; and the idle time measured by the node for substituting the root node exceeds a certain idle time that is longer than the longest privilege acquisition idle time width measured by the root node.

5. The communication network system according to claim 4, wherein:
the nodes include a plurality of the nodes for substituting the root node; and
the plurality of the nodes for substituting the root node measures the certain idle times that are different in time length from each other and that are longer than the longest privilege acquisition idle time width measured by the root node.

6. The communication network system according to claim 1, wherein:
when the requested node, which is the node requested by the master node to transmit data, determines that the requested node cannot respond during the retention of the master privilege by the master node, the requested node transmits a data that is not processed by a receiver.

7. The communication network system according to claim 1, wherein:
when the master node determines that the master node cannot transmit data during the retention of the master privilege by the master node, the master node transmits data that is not processed by a receiver.

8. A master privilege controller provided in each master candidate node, which is included in a plurality of nodes connected to a common transmission line in a communication network and which is capable of becoming a master node, the master privilege controller comprising an idle time measurement device as recited in claim 1.

9. The master privilege controller according to claim 8, further comprising:
a master privilege release device, wherein:
a privilege acquisition idle time width is set in each master candidate node and set as a time width of the idle time within which the each master candidate node can acquire a master privilege, which is a privilege of starting communications by itself;
the privilege acquisition idle time widths of the master candidate nodes are different in time length from each other;
once a master candidate node acquires the master privilege and becomes the master node, the master node retains the master privilege until the idle time of the transmission line exceeds the privilege acquisition idle time width of the master node;
one of the nodes is set as a root node;
when the idle time of the transmission line exceeds a longest privilege acquisition idle time width, which is longest among the privilege acquisition idle time widths of the master candidate nodes, the root node transmits a start frame indicating start of a next communicant cycle; and
the master privilege release device releases the master privilege when a time period of retention of the master privilege by the master node exceeds a maximum retention time.

10. The master privilege controller according to claim 8, further comprising:
a communication cycle time measurement device for measuring a duration of a communication cycle, wherein a starting point of the communication cycle is the transmission of the start frame,
wherein:
when the master candidate node including the master privilege controller is the root node, the root node transmits the start frame if the duration of the communication cycle exceeds a predetermined minimum time and the idle time of the transmission line exceeds the longest privilege acquisition idle time width.
